(19) United States
(12) Patent Application Publication
(10) Pub. No.: US 2008/0158208 A1
(43) Pub. Date: Jul. 3, 2008

(54) Debugging system for liquid crystal display device and method for debugging same

(75) Inventors: Kuang-Liang Huang, Miao-Li (TW); Liang-Yan Dai, Shenzhen (CN); Tong-Xiu Cao, Shenzhen (CN); Ye Zhang, Shenzhen (CN); Wei Wang, Shenzhen (CN); Yan-Bo Yu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/005,957

(22) Filed: Dec. 28, 2007

(30) Foreign Application Priority Data
Dec. 29, 2006 (TW) 95149712

(51) Int. Cl. G09G 5/00; G09G 3/36

(52) U.S. Cl. 345/204; 345/87

(57) ABSTRACT

An exemplary debugging system (2) for a liquid crystal display device (26) includes a host computer (22). The host computer includes a graphics card (220), a driver layer (225), and an application layer (226). The application layer includes a graphical user interface, and the driver layer includes a plurality of drivers to drive the graphics card. The host computer is configured for storing chip data of a scaler chip (260) of the liquid crystal display device, reading and writing the scaler chip via the graphics card, and displaying corresponding chip data on the liquid crystal display device via the graphical user interface such that the corresponding chip data can be revised in a debugging process of the liquid crystal display device.

### FIELD OF THE INVENTION

The present invention relates to systems and methods for debugging display devices, and particularly to a system and a method for debugging a liquid crystal display (LCD) device.

### BACKGROUND

LCD devices are commonly used as displays for compact electronic apparatuses. This is not only because they provide good quality images with little power consumption, but also because they are very thin. Generally, an on-screen display (OSD) function is built into an LCD device. The OSD is typically used by a viewer to locally adjust various important display parameters. Such display parameters include brightness, color contrast, Gamma correction, Standard Red Green Blue (sRGB), display size, and display scaling. These parameters can be adjusted by the viewer operating a push button control panel of the LCD device. Firmware pre-installed in a scaler chip of the LCD device is used to regulate the above-mentioned parameters of the LCD device.

In a process of designing firmware for the LCD device, a debugging engineer needs to debug the scaler chip of the LCD device in order to obtain appropriate display regulation parameters. The debugging engineer then burns corresponding parameter data into the scaler chip. The parameter data cannot be changed once they are burned in the scaler chip. Therefore, debugging the scaler chip in the firmware design process for the LCD device is very important.

Referring to FIG. 3, a conventional debugging system for an LCD device is shown, together with an LCD device. The debugging system 1 includes a host computer 10, a monitor 12, and a conversion module 14. The LCD device 16 being debugged includes a scaler chip (not shown). A debugging operating system corresponding to the scaler chip is installed in the host computer 10. The host computer 10 is connected to the LCD device 16 via the conversion module 14. The monitor 12 is connected to the host computer 10 to display an interface of the debugging operating system.

When the LCD device 16 is debugged, the host computer 10 reads parameter data of the LCD device 16 from the scaler chip via the conversion module 14, and displays the parameter data on the monitor 12. The parameter data include brightness, color contrast, display size, display scaling, and so on. The debugging engineer revises the parameter data displayed on the monitor 12 using input devices such as a mouse and a keyboard. After that, the host computer 10 compiles and writes the revised parameter data in the scaler chip. Then the debugging engineer needs to connect the LCD device 16 to a video source such as another host computer. The video source provides a video signal to the LCD device 16, and the debugging engineer operates the LCD device 16 to observe the results of the debugging.

However, if the debugging results after operating the LCD device 16 are unsatisfactory, the debugging engineer must connect the LCD device 16 to the host computer 10 via the conversion module 14 once again, revise corresponding parameter data, and then observe the results by operating the LCD device 16 after reconnecting the LCD device 16 to the video source. The above procedures may need to be repeated more than once until appropriate debugging results are achieved. Therefore it may take a long time to debug the LCD device 16. Overall, the firmware design process of the LCD device 16 is prone to be tedious and difficult. In addition, each kind of scaler chip needs a debugging operating system which is compatible with that particular kind of scaler chip. If the type of scaler chip of the LCD device 16 is changed, this may necessitate changing the corresponding operating system to be used for debugging the LCD device 16. Therefore the firmware design process for the LCD device 16 can be inconvenient and costly.

What is needed, therefore, is a debugging system for an LCD device which can overcome the above-described deficiencies. What is also needed is a debugging method for an LCD device which can overcome the above-described deficiencies.

### SUMMARY

A debugging system for LCD device is provided. The debugging system includes a host computer. The host computer includes a graphics card, a driver layer, and an application layer. The application layer includes a graphical user interface, and the driver layer includes a plurality of drivers to drive the graphics card. The host computer is configured for storing chip data of a scaler chip of the liquid crystal display device, reading and writing the scaler chip via the graphics card, and displaying corresponding chip data on the liquid crystal display device via the graphical user interface such that the corresponding chip data can be revised in a debugging process of the liquid crystal display device.

A debugging method for an LCD device is also provided. The method includes: providing a debugging system including a host computer, the host computer includes a graphics card, a driver layer, and an application layer, the application layer includes a graphical user interface, and the driver layer includes a plurality of drivers to drive the graphics card; connecting the host computer and the LCD device via the graphics card; the application layer installing the drivers; loading chip data of a scaler chip of the LCD device; revising the corresponding chip data displayed on the LCD device via the graphical user interface; and observing results of the revision on the LCD device via operating the LCD device.

Other novel features and advantages will become more apparent from the following detailed description when taken in conjunction with the accompanying drawings.

### BRIEF DESCRIPTION OF THE DRAWINGS

The emphasis in the drawings is placed upon clearly illustrating the principles of various embodiments of the present invention. Like reference numerals designate corresponding parts throughout various drawings.

FIG. 1 is a block diagram of a debugging system for an LCD device according to a preferred embodiment of the present invention, together with an LCD device.

FIG. 2 is a flowchart of an exemplary debugging method for the LCD device of FIG. 1.

FIG. 3 is a block diagram of a conventional debugging system for an LCD device, together with an LCD device.

### DETAILED DESCRIPTION OF PREFERRED EMBODIMENTS

Reference will now be made to the drawings to describe preferred and exemplary embodiments of the present invention in detail.

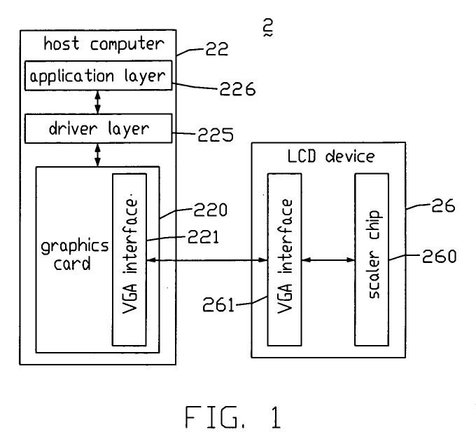

Referring to FIG. 1, a debugging system for an LCD device according to a preferred embodiment of the present invention is shown. The debugging system 2 includes a host computer 22. The host computer 22 includes a graphics card 220, a driver layer 225, and an application layer 226. The graphics card 220 includes a video graphics array (VGA) interface 221. The LCD device 26 includes a scaler chip 260 and a VGA interface 261. The host computer 22 is connected to the LCD device 26 via signal transmission between the two VGA interfaces 221, 261.

The application layer 226 may be a debugging program with a graphical user interface, wherein the graphical user interface can be utilized by displays on the LCD device 26. The application layer 226 communicates with the driver layer 225 via a data transmission channel. The host computer 22 stores chip data of a plurality of different kinds of scaler chips. The driver layer 225 may be a database of 4 GB built by Windows® driver model technology, and includes a plurality of drivers. The drivers correspond to a plurality of different hardware devices, and are used to drive the graphics card 220. A debugging engineer can select a chip type of the scaler chip 260 using the graphical user interface, load the chip data of the scaler chip 260, and input or revise the corresponding chip data using the graphical user interface. The chip data includes parameter data of the LCD device 26, such as brightness, color contrast, display size, display scaling, and so on.

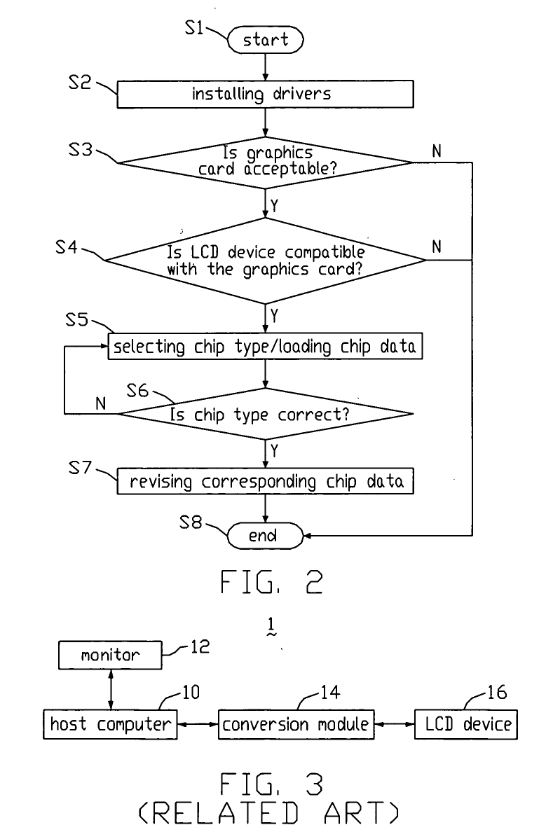

Referring to FIG. 2, a flowchart of an exemplary debugging method for the LCD device 2 is shown. In step S1, the debugging method begins when the host computer 22 is connected to the LCD device 26 by connecting the two VGA interfaces 221, 261 with each other. Thereby, the debugging system 2 can start to operate.

In step S2, the application layer 226 installs the drivers from the driver layer 225.

In step S3, the host computer 22 detects the graphics card 220 via the driver layer 225, and determines whether the graphics card 220 is acceptable. If the graphics card 220 is acceptable, the procedure goes to the next step S4; if not, the debugging process ends.

In step S4, the host computer 22 detects the LCD device 26 via the driver layer 225, and determines whether the LCD device 26 is compatible with the graphics card 220. If the LCD device 26 is compatible with the graphics card 220, the procedure goes to the next step S5; if not, the debugging process ends.

In step S5, in an initial state, the application layer 226 loads chip data of a scaler chip debugged last time, and displays the chip data on the LCD device 26 via the graphical user interface.

In step S6, the host computer 22 detects the scaler chip 260 of the LCD device 26 via the driver layer 225, and determines whether the chip type of the scaler chip 260 is the same as the chip type loaded by the application layer 226. If the chip type of the scaler chip 260 is the same as the chip type loaded by the application layer 226, the procedure goes to the next step S7; if not, the procedure returns to step S5, and the debugging engineer selects the chip type of the scaler chip 260 using the graphical user interface.

In step S7, the host computer 22 reads the chip data from the scaler chip 260 via the two VGA interfaces 221, 261, and displays corresponding chip data on the LCD device 26 via the graphical user interface. The debugging engineer debugs the LCD device 26 by revising the corresponding chip data, which includes revising the parameter data of the LCD device 26. The host computer 22 compiles and writes the revised parameter data to the scaler chip 260 via the driver layer 225 and the two VGA interfaces 221, 261. After this, the debugging engineer can observe the results of the debugging on the LCD device 26 by operating the LCD device 26 directly. If the debugging results are unsatisfactory, the debugging engineer can return to the graphical user interface to revise the corresponding chip data again. This process can be repeated as many times as necessary until the debugging results are satisfactory.

Thus, in step S8, the whole debugging process is completed, and the last revised chip data can be burned in the scaler chip 260.

In summary, the host computer 22 of the debugging system 2 is connected to the LCD device 26 via the two VGA interfaces 221, 261. The host computer 22 directly reads and writes the scaler chip 260 of the LCD device 26 in the debugging process. The debugging engineer can revise the corresponding chip data displayed on the LCD device 26 via the graphical user interface, and then the host computer 22 directly provides a video signal to the LCD device 26, the debugging engineer observes the results of the revision by operating the LCD device 26. That is, the debugging system 2 provides switching of images displayed by the LCD device 26—between displaying chip and other data needed for revising the corresponding chip data, and displaying images needed for observing the debugging results. Therefore the debugging system and method makes the firmware design process for the LCD device 26 simple, time saving, and convenient for the debugging engineer. In addition, the host computer 22 stores chip data of a plurality of different kinds of scaler chips. The debugging engineer can select the correct chip type via the graphical user interface according to the scaler chip 260 of the LCD device 26. Therefore the debugging system and method are suitable for various kinds of scaler chips, which makes the firmware design process for the LCD device 16 convenient and efficient.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A debugging system for a liquid crystal display device, the debugging system comprising:
a host computer comprising a graphics card, a driver layer, and an application layer;
wherein the application layer comprises a graphical user interface, the driver layer comprises a plurality of drivers to drive the graphics card, the host computer is configured for storing chip data of a scaler chip of the liquid crystal display device, reading and writing the scaler chip via the graphics card, and displaying corresponding chip data on the liquid crystal display device via the graphical user interface such that the corresponding chip data can be revised in a debugging process of the liquid crystal display device.

2. The debugging system as claimed in claim 1, wherein the application layer is configured as a debugging program.

3. The debugging system as claimed in claim 1, wherein the application layer is configured for communicating with the driver layer via a data transmission channel.

4. The debugging system as claimed in claim 2, wherein the host computer is configured for storing chip data of a plurality of different kinds of scaler chips.

5. The debugging system as claimed in claim 4, wherein the driver layer is configured as a database of 4 GB built by Windows® driver model technology.

6. The debugging system as claimed in claim 5, wherein the graphics card comprises a video graphics array interface, the liquid crystal display device comprises a corresponding video graphics array interface, and the host computer is connected to the liquid crystal display device via signal transmission between the two video graphics array interfaces.

7. The debugging system as claimed in claim 1, wherein the liquid crystal display device is configured for receiving a video signal directly from the host computer and being operated to observe results of the revision.

8. A debugging method for a liquid crystal display device, the method comprising: providing a debugging system comprising:
a host computer comprising a graphics card, a driver layer, and an application layer, the application layer comprising a graphical user interface, and the driver layer comprising a plurality of drivers to drive the graphics card;
connecting the host computer and the liquid crystal display device via the graphics card;
the application layer installing the drivers;
loading chip data of a scaler chip of the liquid crystal display device;
revising the corresponding chip data displayed on the liquid crystal display device via the graphical user interface; and
observing results of the revision on the liquid crystal display device by operating the liquid crystal display device.

9. The debugging method as claimed in claim 8, further comprising further revising the corresponding chip data if the results of the revision are unsatisfactory.

10. The debugging method as claimed in claim 8, further comprising the host computer providing a video signal to the liquid crystal display device, before observing results of the revision on the liquid crystal display device.

11. The debugging method as claimed in claim 9, wherein the application layer is configured as a debugging program.

12. The debugging method as claimed in claim 11, wherein the application layer is configured for communicating with the driver layer via a data transmission channel.

13. The debugging method as claimed in claim 11, wherein the host computer is configured for storing chip data of a plurality of different kinds of scaler chips, before loading the chip data of the scaler chip of the liquid crystal display device, a correct chip type of the scaler chip is selected via the graphical user interface.

14. The debugging method as claimed in claim 13, wherein the driver layer is configured as a database of 4 GB built by Windows® driver model technology.

15. The debugging method as claimed in claim 8, wherein the graphics card comprises a video graphics array interface, the liquid crystal display device comprises a corresponding video graphics array interface, and the host computer is connected to the liquid crystal display device via signal transmission between the two video graphics array interfaces.
